(19) United States
(12) Patent Application Publication
(10) Pub. No.: US 2009/0260607 A1
(43) Pub. Date: Oct. 22, 2009

(54) OVERCURRENT THRESHOLD CORRECTION FOR IGNITION CONTROL

(76) Inventors: Matthew T. LaDuke, Warren, MI (US); Jack B. Marshall, Detroit, MI (US); Dirk Swanson, Canton, MI (US); Clyde A. Marlow, Saline, MI (US)

Correspondence Address: VISTEON/BRINKS HOFER GILSON & LIONE, 524 South Main Street, Suite 200, Ann Arbor, MI, 48104, US

(21) Appl. No.: 12/106,988

(22) Filed: Apr. 21, 2008

(51) Int. Cl. F02P 9/00

(52) U.S. Cl. 123/609

(57) ABSTRACT

A system for overcurrent threshold correction in an ignition system. The system includes a control circuit and a current detection circuit. The control circuit has a first and second output. The first output of the control circuit charges a first ignition coil, the second output of the control circuit charges a second ignition coil. The overcurrent detection circuit adjusts the detection of an overcurrent condition, when the charging of the first coil overlaps with the charging of the second coil. Further, the control circuit is in communication with the overcurrent detection circuit to disable the first and second output, when the overcurrent condition is detected.

### BACKGROUND

1. Field of the Invention

The present invention generally relates to a system for overcurrent threshold correction in an ignition system.

2. Description of Related Art

Many automotive electronic ignition control products make use of ignition coil current control circuitry. The purpose of these circuits is to provide a known current charge in the ignition coil at the desired time of the combustion event. These closed loop systems typically use a predictive method to begin the coil charging at a specific time to achieve the desired current charge at the time of combustion. The period during which the coil is charging is referred to as the dwell period. A current sense resistor or some other current sensing mechanism is typically used to measure the dynamic current levels in the drivers and the ignition coils. The current measurement can also be used to protect the driver and ignition coil against overcurrent conditions. This overcurrent protection is typically implemented with a current sense amplifier feeding a comparator circuit. This comparator circuit compares the measured coil current against a fixed reference. If the actual coil current exceeds this fixed reference, an overcurrent condition is identified. When an overcurrent condition is detected, a disable signal is issued to the control logic circuitry, which in turns disables (turns off) the drivers and shuts down the current in the ignition coils.

In some dynamic vehicle operating conditions, it can be necessary to overlap the ignition coil dwell periods to meet the power demands of the vehicle. However, as the dwell periods begin to overlap the likelihood of exceeding the overcurrent threshold increases. With sufficient overlapping dwell the overcurrent threshold will be exceeded, which in turn will disable each active driver and abort the ignition coil charging for these coils. Aborted coil charging events result in degraded ignition system performance. A method of avoiding aborted coil charging under these dynamic vehicle conditions would improve ignition system and overall vehicle performance.

In view of the above, it is apparent that there exists a need to compensate for the overlapping dwell condition preventing aborted ignition coil dwells.

### SUMMARY

In satisfying the above need, as well as overcoming the enumerated drawbacks and other limitations of the related art, the present invention provides a system for overcurrent threshold correction in an ignition system.

The system includes a control circuit and a current detection circuit. The control circuit has a first and second output. The first output of the control circuit charges a first ignition coil, the second output of the control circuit charges a second ignition coil. The overcurrent detection circuit adjusts the detection of an overcurrent condition, when the charging of the first coil overlaps with the charging of the second coil. Further, the control circuit is in communication with the overcurrent detection circuit to disable the first and second output, when the overcurrent condition is detected.

In another aspect of the invention, the system includes a first and second driver, the first output controls the first driver and the second output controls the second driver. Each of the first and second drivers being in electrical series connection with the first and second coil respectively. Further, the first switch and first coil are in electrical parallel connection with the second switch and the second coil. The first and second switch is in communication with the overcurrent detection circuit at a node allowing the current from both the first and second coil to be provided to the overcurrent detection circuit.

The control circuit sends an overlap signal to the overcurrent detection circuit when the charging of the first coil in the charging of the second coil overlap. The overcurrent detection circuit compares an overcurrent threshold to the current signal to detect the overcurrent condition. Further, the current detection circuit adjusts the overcurrent threshold based on the overlap signal while the charging of the first coil overlaps the charging of the second coil. The overcurrent detection circuit provides an overcurrent signal to the control circuit to disable the first and second output based on the comparison of the overcurrent threshold and the current signal. As such, the overcurrent detection circuit provides a feedback loop to the control circuit, based on whether the charging of the first coil and the charging of the second coil overlap.

Accordingly, the proposed solution addresses the overlapping dwell situation by incorporating more intelligence in the control logic of the system. The control logic is, therefore, able to detect the presence of overlapping dwell and dynamically adjust the overcurrent threshold allowing overlapping dwell operation without prematurely tripping overcurrent shutdown.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a system for overcurrent threshold correction;

FIG. 2 is a graph illustrating the current flow through the first and second coil when charging of the first and second coil do not overlap;

FIG. 3 is a graph of the current flow through the first and second coil when the first and second coil overlap;

FIG. 4 is a graph illustrating the current flow through the first and second coil and a prematurely aborted dwell of the ignition system; and

FIG. 5 is a graph illustrating the adjustment of the overcurrent threshold while charging of the first and second coil overlap.

### DETAILED DESCRIPTION

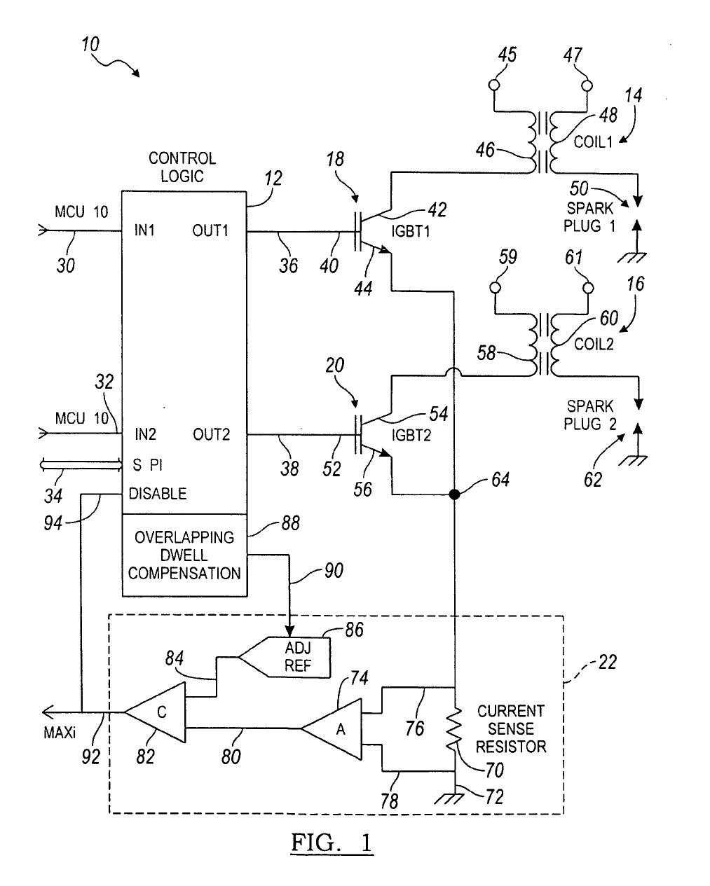

Referring now to FIG. 1, a system 10 includes a control logic circuit 12 for controlling a first and second coil 14, 16 of an engine and a current detection circuit 22. The control circuit 12 includes a first input 30 for charging of the first coil 14 and a second input 32 for charging of the second coil 16. The first and second input 30, 32 may be digital logic signals, for example, provided by a central processing unit (CPU) within the vehicle. In addition, the circuit 12 includes a serial peripheral interface 34 allowing various parameters within the control circuit 12 to be adjusted by a vehicle CPU. The control circuit 12 has a first output 36 that controls the charging of the first coil 14 and a second output 38 that controls charging of the second coil 16. The first output 36 is in communication with the driver 18 to charge first coil 14. The second output 38 is in communication with the driver 20 to charge first coil 16. The drivers 18 and 20 may be solid-state switches, such as a power transistor and are shown as insulated gate bipolar transistors (IGBT) in FIG. 1. Although, it is understood by one of ordinary skill in the art that other transistors or solid-state switches may be used as an alternative to an IGBT. For illustrative purposes, the driver 18 and the driver 20 will be referred to as transistor 18 and transistor 20 with regard to the further description of FIG. 1.

Accordingly, first output 36 is connected to the base 40 of transistor 18. The collector 42 of transistor 18 is connected to one end of a first side 46 of coil 14. The other end of the first side 46 of coil 14 is connected to a reference voltage 45. The emitter 44 of transistor 18 is connected to the current detection circuit 22 and thereby to a reference ground 72. As such, when transistor 18 is active, current flows from reference voltage 45 through the first side 46 of coil 14 into the collector 42 of transistor 18, then out of the emitter 44 of transistor 18, through the current detection circuit 22 to reference ground 72. Current flowing through the first side of coil 46 introduces a potential across the second side 48 of coil 14. The second side 48 of coil 14 is connected on one end to reference voltage 47 and on the other end to a spark plug 50. The build-up of potential across the second side 48 of the coil 14 builds until a spark is generated through the spark plug 50.

The second output 38 is connected to the base 52 of transistor 20. The collector 54 of transistor 20 is connected to one end of a first side 58 of coil 16. The other end of the first side 58 of coil 16 is connected to a reference voltage 59. The emitter 56 of transistor 20 is connected to the current detection circuit 22 and, thereby, to a reference ground 72. As such, when transistor 20 is active, current flows from reference voltage 59 through the first side 58 of coil 16 into the collector 54 of transistor 20, then out of the emitter 56 of transistor 20, through the current detection circuit 22 to reference ground 72. Current flowing through the first side of coil 58 introduces a potential across the second side 60 of coil 16. The second side 60 of coil 16 is connected on one end to reference voltage 61 and on the other end to a spark plug 62. The build-up of potential across the second side 60 of the coil 16 builds until a spark is generated through the spark plug 62.

In this embodiment, the first and second transistor 18 and 20 are in electrical parallel connection prior to the current detection circuit 22. Accordingly, the emitter 44 of the first transistor 18 and the emitter 56 of the second transistor 20 are connected to node 64 and are, therefore, connected to a first side of current sense resistor 70. The second side of current resistor 70 is connected to a voltage reference 72. Accordingly, the current flowing through the first side 46 of the first coil 14 and the first side 58 of the second coil 16 are additive, thereby forming a voltage drop across current sense resistor 70 corresponding to the current flowing through both the first and second coil 14, 16. An amplifier 74 includes a first input 76 connected to a first side of current sense resistor 70 and a second input 78 connected to the second side of current sense resistor 70. As such, the amplifier 74 generates an electrical signal 80 corresponding to the current flowing through both the first coil 14 and the second coil 16. The electrical signal 80 is provided to a comparator 82. The comparator 82 also receives a second overcurrent threshold signal 84. Accordingly, the comparator 82 generates an overcurrent output signal 92, if the signal 80 corresponding to the current flow through the first and second coil 14, 16 exceeds the overcurrent threshold signal 84. The overcurrent signal 92 is provided to a disable input 94 of the control logic 12. As such, the control logic 12 can disable the first and/or the second output 36, 38 based on the overcurrent output 92 provided to disable input 94.

An overlapping dwell compensation module 88 is included in the control logic circuit 12. The overlapping dwell compensation module 88 determines if the first and second outputs 30, 32 are overlapped and generates an overlap signal 90 indicating the overlap time period. The overlap signal 90 is provided to an overcurrent threshold reference adjustment module 86. The module 86 adjusts the overcurrent threshold signal 84 if the first and second input signals 36, 38 are overlapping. As such, the overlap signal 90 and the overcurrent signal 94 form a feedback loop between the control circuit 12 and the current detection circuit 22.

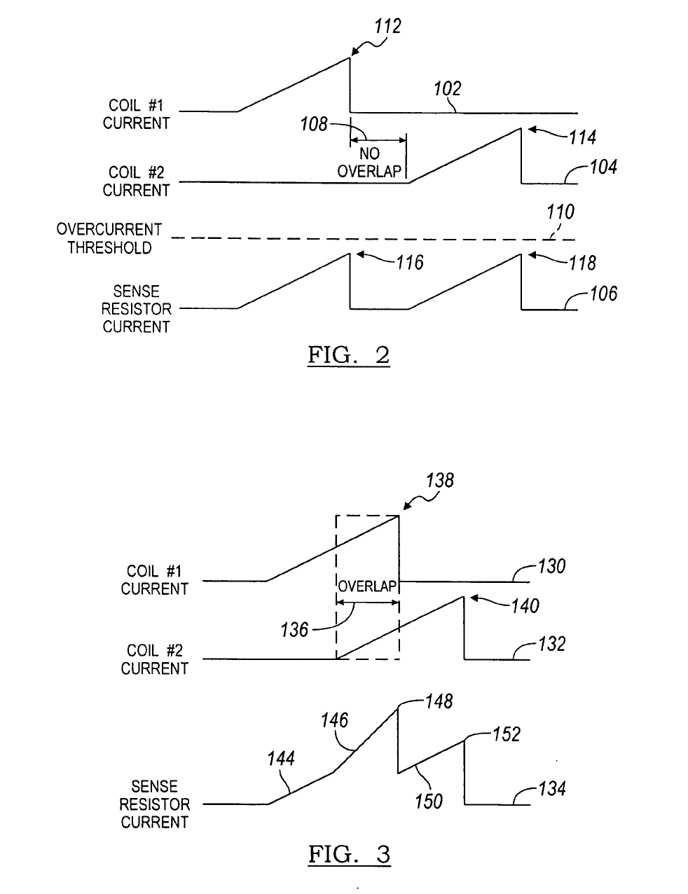

The affects of the feedback loop can be better understood by reviewing the illustrations in FIGS. 2-5. In FIG. 2, the current through the first coil is denoted by line 102 and the current through the second coil is denoted by line 104. The charging of the first coil 14 is denoted by reference numeral 112 while the charging of the second coil 16 is denoted by reference numeral 114. The charging 112 of the first coil 14 and the charging 114 of the second coil 16 are separated by a time delay and do not overlap, as denoted by arrow 108. At node 64, the current through the first coil 14 is added with the current through the second coil 16. As such, the current through the current sense resistor 70 is depicted by line 106. In line 106, the charging of the first coil 14 is denoted by reference numeral 116 and the charging of the second coil 16 is denoted by reference numeral 118. In this scenario, a constant overcurrent threshold 110 may be used to disable the control circuit 12 in the event of an overcurrent condition.

FIG. 3 illustrates the scenario where the charging of the first and second coil 14, 16 overlap. Line 130 represents the current through the first coil 14 and line 132 represents the current through the second coil 16. Charging of the first coil 14 is denoted by reference numeral 138. Charging of the second coil 16 is denoted by reference numeral 140. The overlap in the charging of the first coil 14 and charging of the second coil 16 is denoted by arrow 136. The resulting current through the current sense resistor 70 is illustrated by line 134. Segment 144 represents the time that only the first coil 14 is charging, while segment 146 represents the overlap period when both the first and second coil 14, 16 are charging. Reference number 148 denotes the ignition of the first coil 14. Then, the second coil 16 continues to charge, as denoted by segment 150, until the ignition of the second coil 16 as denoted by reference number 152.

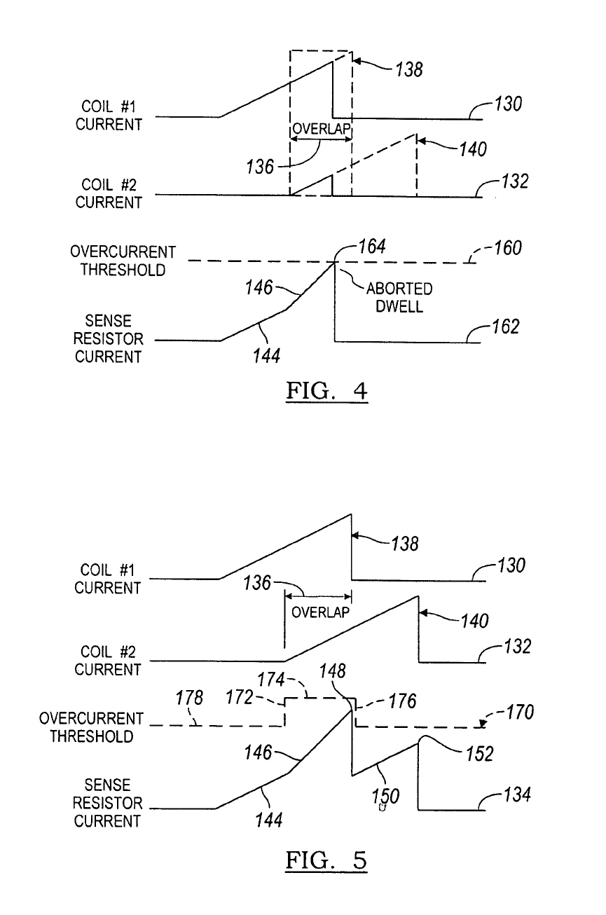

FIG. 4, illustrates a system utilizing a consistent overcurrent threshold, as denoted by line 160. As such, the charging of the first and second coil 14, 16 may be aborted prior to the ignition of one or both coils, as denoted by reference numeral 164, resulting in the current profile denoted by line 162. Utilizing an adjustable overcurrent threshold as denoted by line 170 in FIG. 5, this problem can be avoided. The reference adjustment module 86 may set the overcurrent threshold to a first level 178 while one of the coils is charging. The overcurrent threshold may be increased, as denoted by reference numeral 172, to a second level 174 while both coils are charging. After the ignition of the first coil 14, the reference adjustment module 86 may decrease the overcurrent threshold back to the single coil charging level 178, as denoted by reference numeral 176. Providing this dynamic feedback to the overcurrent threshold allows the engine to overlap charging when appropriate while eliminating the problem of inadvertent ignition aborts.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

We claim:

1. A system for controlling ignition coils, the system comprising:
a control circuit having a first and second output, the first output being configured to control charging of a first coil, the second output being configured to control charging of a second coil;
an overcurrent detection circuit configured to adjust detection of an overcurrent condition when charging of a first coil overlaps with charging of the second coil.

2. A system according to claim 1, wherein the control circuit is configured to disable the first and second output when the overcurrent condition is detected.

3. The system according to claim 1, further comprising a first and second switch, the first output being configured to control the first switch and the second output being configured to control the second switch, the first switch being in electrical series connection with the first coil and the second switch being in electrical series connection with the second coil.

4. The system according to claim 3, wherein, the first switch and first coil being in electrical parallel connection with the second switch and the second coil.

5. The system according to claim 3, wherein the first and second switch are in communication with the overcurrent detection circuit at a node, thereby allowing a first current flowing though the first coil and a second current flowing through the second coil to both be provided to the overcurrent detection circuit through the node.

6. The system according to claim 3, wherein the first switch is a first transistor and the base of the first transistor is connected to the first output, the collector of the first transistor is connected to the first coil and the emitter of the first transistor is connected to the node.

7. The system according to claim 6, wherein the second switch is a transistor and the base of the second transistor is connected to the second output, the collector of the second transistor is connected to the second coil and the emitter of the second transistor is connected to the node.

8. The system according to claim 3, wherein the control circuit sends an overlap signal to the overcurrent detection circuit.

9. The system according to claim 8, wherein the overcurrent detection circuit compares an overcurrent threshold to the signal to detect the overcurrent condition.

10. The system according to claim 9, wherein the overcurrent detection circuit adjusts the overcurrent threshold while the charging of the first coil overlaps charging of the second coil.

11. The system according to claim 10, wherein the overcurrent detection circuit provides an overcurrent signal to the control circuit to disable the first and second output.

12. The system according to claim 1, wherein the overcurrent detection circuit provides a feedback loop to the control circuit based on whether the charging of the first coil and charging of the second coil overlap.

13. A system for controlling ignition coils, the system comprising:
a control circuit having a first and second output, the first output being configured to control charging of a first coil, the second output being configured to control charging of a second coil;
an overcurrent detection circuit configured to adjust detection of an overcurrent condition when charging of a first coil overlaps with charging of the second coil;
a first and second switch, the first output being configured to control the first switch and the second output being configured to control the second switch, the first switch being in electrical series connection with the first coil and the second switch being in electrical series connection with the second coil, the first switch and first coil being in electrical parallel connection with the second switch and the second coil, the first and second switch being in communication with the overcurrent detection circuit at a node, thereby allowing a first current flowing though the first coil and a second current flowing through the second coil to both be provided to the overcurrent detection circuit through the node.

14. The system according to claim 13, wherein the control circuit sends an overlap signal to the overcurrent detection circuit.

15. The system according to claim 14, wherein the overcurrent detection circuit compares an overcurrent threshold to the signal to detect the overcurrent condition.

16. The system according to claim 15, wherein the overcurrent detection circuit adjusts the overcurrent threshold while the charging of the first coil overlaps charging of the second coil.

17. A method for controlling ignition coils, the method comprising the steps of:
generating a first control signal;
generating a second control signal;
determining if charging of the first coil and charging of the second coil overlap;
sensing current through the first and second coil;
generating a current signal corresponding to the current through the first and second coil;
comparing the current signal to an overcurrent threshold;
adjusting the overcurrent threshold based on whether charging of the first coil and charging of the second coil overlap.

18. The method according to claim 17, further comprising generating an overcurrent signal when the current signal exceeds the overcurrent threshold.

19. The method according to claim 17, further comprising disabling the first and second control signal based on the overcurrent signal.

20. The method according to claim 17, wherein the overcurrent threshold is raised during a time period where charging the first time period and charging the second coil overlap.
